(19) United States
(12) Patent Application Publication
(10) Pub. No.: US 2016/0075001 A1
(43) Pub. Date: Mar. 17, 2016

(54) MOUNTING WRENCH FOR A TOOL HEAD

(71) Applicant: Kennametal Inc., Latrobe, PA (US)

(72) Inventors: Julia TEMPELMEIER, Roth (DE); Jürgen Schwagerl, Vohenstrasse (DE); Herbert Rudolf Kauper, Erlangen (DE); Tim Guter, Furth (DE); Berthold Heinrich Zeug, Furth (DE); Rainer Büttner, Wilhermsdorf (DE); Peter Sollfrank, Waldthum (DE); Gunnar Schmitt, Kupferberg (DE)

(21) Appl. No.: 14/851,988

(22) Filed: Sep. 11, 2015

(30) Foreign Application Priority Data
Sep. 12, 2014 (DE) 102014218373.1

(51) Int. Cl. B25B 13/50; B25B 13/06

(52) U.S. Cl. CPC B25B 13/50; B25B 13/065

(57) ABSTRACT

The mounting wrench (2) is used to engage or disengage a tool head (24) of a modular tool. The mounting wrench (2) incorporates a base body (4), which extends from an upper surface (20) along a centered longitudinal axis (18) to an underside (22). In addition, it has a slotted part (6), extending in the direction of the centered longitudinal axis (18), with a slot (10), into which the tool head (24) can be inserted. The slotted part (6) has two opposing keys (14), extending radially inward, which are each designed to mesh into a keyway (30) of the tool head (24). The keys (14) have a rounded end face (32), oriented radially inward, and are sloped relative to the centered longitudinal axis (18) so that the distance (a) between the keys (14) increases in the direction of the centered longitudinal axis (18).

### RELATED APPLICATION DATA

The present application claims priority under 35 U.S.C. §119(a) to German Patent Application Number 102014218373.1 filed Sep. 12, 2014 which is hereby incorporated by reference in its entirety.

### FIELD

The invention concerns a mounting wrench for a tool head which can be interchangeably mounted on a tool holder of a modular tool.

### BACKGROUND

This type of modular tool typically concerns modular drilling tools. A modular drilling tool of this type can be found, for example, in EP 1 476 269 B1.

The tool head described there is characterized, in particular, in that it is first inserted radially into a socket of the tool holder using an attachment pin and is then twisted to form a positive fit in the socket. This type of tool head is solely attached by being clamped in the tool mount of the tool holder. Here, no additional fastening devices are provided.

In principle, mounting wrenches for assembling and disassembling the tool head are known, with which the rotational movement required for attaching or releasing can be exerted. Here, keyways are designed in the form of notches at regular intervals on the face or the circumference of the tool head, into which the mounting wrench meshes.

Mounting wrenches are known in which metal plates, which mesh into the keyways of the tool head, are incorporated within a base body. Mounting wrenches are also known which are designed in the form of open-ended wrenches.

### SUMMARY

Based on this, the task underlying the invention is to provide an improved mounting wrench. The problem is solved in accordance with the invention by a mounting wrench for a tool head with the features of claim 1. The mounting wrench incorporates a base body, which extends from an upper surface to an underside along a centered longitudinal axis. In addition, the base body has a slotted part extending in the direction of the centered longitudinal axis with a slot into which the tool head can be inserted. In turn, the slotted part has two opposing keys, extending radially inward, which are each designed to mesh into a keyway of the tool head. At the same time, the keys have an end face oriented radially inward, which has a rounded design. In addition, the keys are sloped relative to the centered longitudinal axis, so that the distance between the keys then increases in the direction of the centered longitudinal axis, from the upper surface toward the underside.

Thanks to the specific design of the keys, gentler meshing into the keyway of the tool head is achieved in comparison with the known and comparatively sharp-edged metal plates.

Thanks to the sloped design of the keys with the widening distance, one and the same mounting wrench can be utilized, advantageously, for tool heads with different head diameters. Here, the distance preferably varies over multiple tool head diameter sizes and varies, for example, by between 2 and 6 mm.

A particular advantage can be seen in the rounded design of the keys. As a result of this, in comparison with metal plates at the base, that is in a connection area with the slotted part, these are designed to be comparatively massive and hence stable. In addition, thanks to the rounded end face, no sharp edges are formed. Thus, overall, gentle meshing is achieved. At the same time, the keys are designed to be particularly stable. This also allows the keys to be made from plastic and not from metal, which is particularly advantageous for gentle meshing.

Hence, in a convenient embodiment, at least the slotted part and the keys are designed as a one-piece plastic component, in particular, an injection molded component. Conveniently, the entire mounting wrench is formed as a plastic component. Here, in principle, there is the option of embedding at least one reinforcing element made from metal, for example, within the plastic of the one-piece part, in particular, in the areas of the keys. It is crucial that the functional elements, namely the slotted part and the keys, have plastic external surfaces. Preferably, however, the mounting wrench is a purely massive plastic component. In principle, the mounting wrench can also consist of another material, for example, metal. For this purpose, the mounting wrench is formed, for example, as a die-cast component or even manufactured with the aid of a 3-D printing process.

In a preferred embodiment, the rounded end faces, viewed from overhead in the direction of the centered longitudinal axis, are designed as circular arcs. Generally, rounded means that the end faces follow a line of arc. Here, the radius of this line of arc is typically in the range of between 0.6 mm and 3.4 mm.

In accordance with a first embodiment variant, the keys taper radially relative to the centered longitudinal axis. Hence, relative to the slotted part, they have a widened base so that, with the slotted part, they are suitably firmly and massively designed for the transfer of high levels of torsional force. In particular, the keys here, viewed from overhead in the direction of the centered longitudinal axis, are approximately triangular in design, with rounded-off corner regions. In this embodiment variant, the end face is preferably also designed as a circular arc with a radius in the range of between 0.6 mm and 3.4 mm.

In accordance with an alternate embodiment, the keys, viewed from overhead in the direction of the centered longitudinal axis, are designed in the form of a semicircular segment, to which another foot section is attached in a radial direction, if required, with, in particular, a consistent width. Thus, the width of the foot section conforms with the diameter of the semicircle. Here, the width of the foot section, and hence the diameter of the semicircle, corresponds to the width of the foot section of the embodiment variant described above, with the key tapering inward. In both embodiment variants, the keys preferably have a width in the range of between 2.4 and 17 mm in their foot section, that is, in the transfer section for the slotted part.

In a convenient development, the slot of the slotted part is cylindrical in overall design, with a cylindrical inner wall, wherein the keys are formed on the inner wall of the cylinder, that is, protruding from this. In the embodiment variant as a one-piece plastic part, the keys are therefore formed as one-piece mold-cast elements.

In a preferred embodiment, the keys level off to the wall of the cylinder toward the underside so that the maximum distance between the opposing keys is the diameter of the cylindrical slot.

In a preferred development, the keys have a first parallel section, to which a section sloped toward the underside in the direction of the centered longitudinal axis is attached. The distance between the keys within the parallel section is consistent and the distance between the keys increases within the sloped section. As a result of this, a stable design of the keys is achieved in the area toward the upper surface. It is also guaranteed even for small nominal tool head diameters, for which the areas of the mounting wrench with the smallest distance mesh with the keyways on the tool head, that the keys are still adequately stable for the transfer of the torque required.

In a preferred development, in addition to the keys, two further opposing locating pins are formed, extending radially inward, which are designed to mesh in flutes on the tool head. At the same time, these locating pins also conveniently have a rounded design. Here, in addition, they are designed so that, for mounting wrenches attached to the tool head, they are at a distance from the flutes, and so are not in contact with these. Primarily, these serve as locators for the correct positioning of the mounting wrench on the tool head. Hence, overall, both effective protection of the cutting edges and precise positioning with protection against the risk of injury is guaranteed by the mounting wrench described here. Thanks to the locating pin, incorrect positioning, and hence also the risk of damage to the cutting edges due to this type of incorrect attachment, is prevented.

Conveniently, the keys and the locating pins generally have different geometries.

Here, a particular locating pin is arranged between the two keys. The particular locating pin preferably has different angular distances relative to the two adjacent keys, and is thus arranged asymmetrically in respect of the keys. As a result of this, particularly in conjunction with the different geometries of the locating pins and the keys, the correct positioning of the mounting wrench on the tool head is ensured. Hence, in addition, damage to the cutting edges is also reliably prevented. The specific design is selected for this so that the locating pins do not come into contact with the cutting edges and do not press against these.

In addition, the locating pins preferably have an approximately crescent-shaped cross-section and therefore have a convex surface section and a concave surface section. Due to this design, they approximate the typical cross-sectional shape of the flutes. This ensures that the locating pins are spaced apart from a flute wall in all areas.

Here, the locating pins preferably run parallel to the centered longitudinal axis and are also at the same distance from one another over their entire length in the direction of the centered longitudinal axis.

With regard to the easiest possible operation, the mounting wrench also incorporates two lateral wing arms, which are attached to the centrally arranged slotted part. The wing arms, in particular, are plastic arms, which, with the central slotted part, form the one-piece plastic part in the design of the mounting wrench. Hence, the overall design of the mounting wrench is in the form of a wing nut. Alternately, the wing arms are comprised of another material, for example metal (steel).

### BRIEF DESCRIPTION OF THE DRAWINGS

An exemplary embodiment of the invention is outlined in more detail in the following, with the aid of the figures. In the drawings:

FIG. 1 is a perspective representation of a mounting wrench with a tool head attached,

FIG. 2 is an overhead view of an upper surface of the mounting wrench without a tool head attached,

FIG. 3 is a sectional perspective representation of a mounting wrench with a tool head attached,

FIG. 4 is an overhead view of the mounting wrench with a tool head attached, and

FIG. 5 is a sectional view of the representation in FIG. 4, along the cut line A-A.

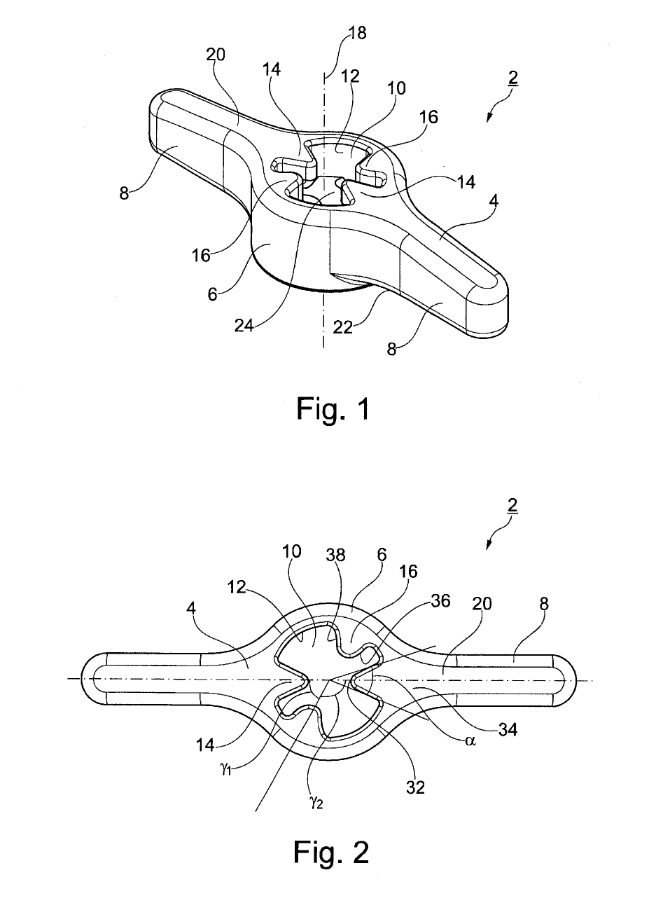

### DETAILED DESCRIPTION

A mounting wrench 2 represented in the figures has a base body 4, which has a central slotted part 6, to which two opposing wing arms 8, extending radially outward, are attached. The central slotted part 6 has an approximately hollow cylindrical geometry with a central slot 10, which has a cylindrical basic geometry with an inner cylinder wall 12. This inner cylinder wall 12 forms two opposing keys 14 and two opposing locating pins 16, each of which is oriented radially inward. Here, the slot 10 extends along a centered longitudinal axis 18 from an upper surface 20 to an undersurface 22 of the mounting wrench 2.

The slot 10 is used to attach a modular tool, not represented here, on a tool head 24 and accommodates this. This modular tool is generally a machining tool, in particular, a rotary tool and preferably a drilling tool, which, in operation, rotates around its rotational axis. The tool head 24 is also designed with an attachment pin 26 on its underside, which is inserted into a socket of the tool holder, not represented here, of the tool 24. Here, the tool head 24 is preferably attached purely by clamping, by turning the tool head 24 relative to the tool holder. The tool head 24 typically has flutes 28, which are, for example, extended in the tool holder.

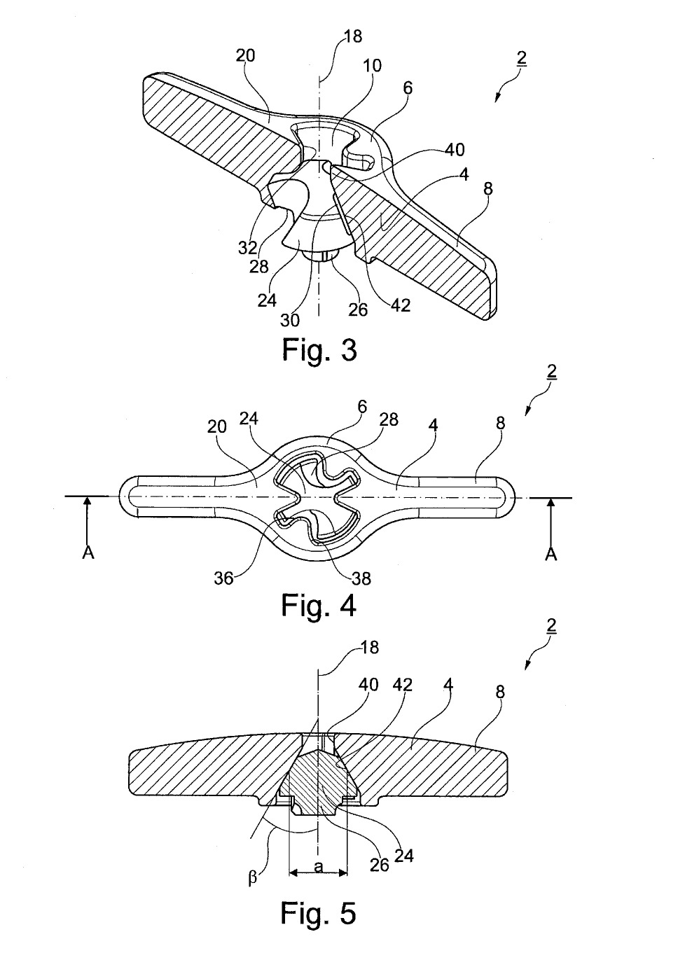

As can be seen, particularly in FIG. 3, the tool head 24 has two opposing keyways 30 on its face and/or its circumference, into which the keys 14 mesh when in use.

In a convenient embodiment, the entire mounting wrench 2 is designed as a massive, one-piece plastic part. The slotted part 6 with the wing arms 8 is aligned on the upper surface 20, and thus merges into the wing arms 8 without indentations. In contrast, a central ring is formed on the underside, so that a step is formed in the transition section from the slotted part 6 to the wing arms 8, as can be easily seen, particularly in FIGS. 3 and 5. As can also be seen in FIG. 5, the upper surface 20 is slightly curved.

The keys 14 and the locating pins 16 each have an end face 32, oriented centrally inward relative to the centered longitudinal axis 18, which has a rounded design and which, particularly viewed in cross-section, forms a line of arc. As can be seen, particularly in the overhead view according to FIG. 2, the keys 14, viewed in cross-section, are designed in the form of a triangle and broaden from the end face 32 toward a foot section 34, to which they are connected by the inner wall of the cylinder 12. In the exemplary embodiment, the foot section 34 extends over an angular range α of approximately 60°. The foot section 34 generally extends over an angular range α, for example, in the range of between 45° and 75°.

As can easily be seen, particularly by reference to FIG. 3 and FIG. 5, the keys 14 run in the direction of the centered longitudinal axis 18 at a slope relative to the underside 22 and level off completely, in particular, relative to the inner wall of the cylinder 12. The end face 32 is thus sloped at an angle of incline β relative to the centered longitudinal axis 18. Here, in the exemplary embodiment, the angle of incline β is approximately 30° and, in general, is preferably between 15° and 45° . The keys 14 and the locating pins 16 run in the direction of the centered longitudinal axis, each parallel to this, and are therefore not formed on the inner wall of the cylinder 12 as spirals or helices.

As can also be seen, the keys 14 initially have a parallel section 40, toward the upper surface 20, which is oriented parallel to the centered longitudinal axis 18. A sloped section 42 then adjoins this, within which the distance a continually expands. Here, the sloped section 42 extends over approximately 65% to 90% of the overall length of the key 14 in the direction of the centered longitudinal axis 18.

Hence, due to this slope, the distance a between the keys 14 continuously increases toward the underside 22. At the same time, as can easily be seen in FIG. 5, the end faces 32 run in a straight line.

The keys 14 are generally designed as symmetrical relative to a central axis, that is, the lateral surfaces attached to the end face 32 are designed to be mirror-symmetric to one another.

In contrast to this, the locating pins 16, viewed in cross-section, have an approximately crescent-shaped design and have a convex surface section 36 and a concave surface section 38. Due to this, they approximate the typical cross-sectional geometry of the flutes 28. As can be seen, particularly in the overhead view according to FIG. 4, the locating pins 16 only mesh into the flutes 28, without, however, coming into contact with the flute walls.

In contrast to this, the keys 14 mesh into the keyways 30 with a positive fit and, in fact, so that the lateral walls of the keys 14 on both sides are enclosed by the corresponding opposing lateral walls of the keyway. Hence, the entire mounting wrench 2 is attached on the tool head 24 free of play.

Thanks to the double sloped design, that is, thanks to the design tapered toward the centered longitudinal axis 18 and the sloped path of the end face 32 with the changing distance a in the direction of the centered longitudinal axis 18, a reliable, torque-proof and interlocking meshing is also guaranteed for different embodiments of the tool head 24.

A particular key 14 with a particular locating pin 16 forms a guideway pair. A particular locating pin 16 is arranged between the two keys 14. Here, the respective locating pin 16 has different angular distances γ1, γ2 relative to the keys 14. The angular distances γ1, γ2 differ: here, for example, γ2 is twice γ1. This asymmetric arrangement ensures that the mounting wrench 2 can only be attached to the tool head 24 in a defined position.

The tool head 24 is also designed to correspond with this particular design of the mounting wrench 2, in particular, its keyways 30. Here, then, these are positioned particularly in accordance with the arrangement of the keys 14 and the locating pins 16 on the tool head 24 so that the keyways 30 also each have the angular distances γ1, γ2 relative to the flutes 28. In addition, the keyways 30, viewed in cross-section, are designed to be complementary to the keys 14, and thus also conveniently have a rounded base, which has a design complementary to the end face 32, that is, it has the same or at least approximately the same radius as the end face 32. The cross-sectional area of the keyways 30 is also designed to be complementary to that of the keys 14, so that the key 14, then, is accommodated with a completely perfect fit. Thus, in particular, the keyways 30, viewed in cross-section, also have an approximately triangular geometry.

1. Mounting wrench (2) for a tool head (24), which can be interchangeably mounted on a tool holder of a modular tool,
with a base body (4), which extends along a centered longitudinal axis (18), from an upper surface (20) to an undersurface (22),
the base body (4) has a slotted part (6) with a slot (10), extending in the direction of the centered longitudinal axis (18), into which the tool head (24) can be inserted,
the slotted part (6) has two opposing keys (14), extending radially inward, which are each designed to mesh with a keyway (30) of the tool head (24),
the keys (14) have a radially inward oriented end face (32), which has a rounded design,
the keys (14) are sloped relative to the centered longitudinal axis (18) so that the distance (a) between the keys (14) increases in the direction from the upper surface (20) to the underside (22).

2. The mounting wrench (2) in accordance with claim 1, in which at least the slotted part (6) and the keys (14) and preferably the entire mounting wrench (2) is formed as a one-piece plastic component.

3. The mounting wrench (2) in accordance with claim 1, in which the end faces (32), viewed from overhead in cross-section, in the direction of the centered longitudinal axis (18), are formed as a circular arc.

4. The mounting wrench (2) in accordance with claim 1, in which the keys (14) taper in a direction radial to the centered longitudinal axis (18) and, in particular, have an approximately triangular cross-sectional area with the rounded end face.

5. The mounting wrench (2) in accordance with claim 1, in which the slot (10) is cylindrical, with an inner wall of the cylinder (12), and the keys (14) are formed on the inner wall of the cylinder (12).

6. The mounting wrench (2) in accordance with claim 5, in which the keys (14) run from the underside (22) to the inner wall of the cylinder (12).

7. The mounting wrench (2) in accordance with claim 1, in which the keys (14) have a parallel section (40), within which the distance (a) between the keys (14) is consistent and to which a sloped section (42) is attached, within which the distance (a) increases in the direction of the centered longitudinal axis (18) toward the underside (22).

8. The mounting wrench (2) in accordance with claim 1, in which two additional locating pins (16), extending radially inward and arranged opposite each other, are formed in the slot (10), which are designed to mesh into flutes (28) in the tool head (24).

9. The mounting wrench (2) in accordance with claim 8, in which the locating pins (16) have a different geometry from the keys (14).

10. The mounting wrench (2) in accordance with claim 8, in which a particular locating pin (16) is arranged between the two keys (14), wherein the angular distance (γ1, γ2) of the respective locating pin (16) from the two keys (14) is different.

11. The mounting wrench (2) in accordance with claim 8, in which the locating pins (16), viewed from overhead in the direction of the centered longitudinal axis (18), are crescent-shaped with a convex surface section (36) and with a concave surface section (38).

12. The mounting wrench (2) in accordance with claim 1, in which the base body (4) has two lateral wing arms (8), which are connected to the centrally arranged slotted part (6).
